(19) United States
(12) Patent Application Publication
(10) Pub. No.: US 2017/0032252 A1
(43) Pub. Date: Feb. 2, 2017

(54) METHOD AND SYSTEM FOR PERFORMING DIGITAL INTELLIGENCE

(71) Applicants: John Feminella, Charlottesville, VA (US); James Bradley Kipp, Charlottesville, VA (US)

(72) Inventors: John Feminella, Charlottesville, VA (US); James Bradley Kipp, Charlottesville, VA (US)

(73) Assignee: UPHEX, Charlottesville, VA (US)

(21) Appl. No.: 14/814,790

(22) Filed: Jul. 31, 2015

(51) Int. Cl. G06N 5/02

(52) U.S. Cl. CPC G06N 5/022

(57) ABSTRACT

A method and system of data analytics provide for retrieving data from a plurality of different sources, normalizing the data, predicting one or more values based on the normalized data, analyzing the normalized data based on the prediction, and delivering an output to a user based on the analysis. One such method includes using a computer to extract point observation data from different electronic data sources; converting time-series data into a plurality of reference (time, value) pairs; normalizing the reference (time, value) pairs using a coherence operation to convert the data into interval observation data; performing estimated weighted moving average with a residual bands adjustment to provide a range of predicted values; comparing current (time, value) pairs to the predicted value to identify anomalies.

### BACKGROUND OF THE INVENTION

Field of the Invention

The present invention relates to the field of electronic data analytics. More particularly, the present invention relates to a computer-implemented method and system that provides for retrieving data from a plurality of electronic data sources, normalizing the data, predicting one or more values based on the normalized data, analyzing the normalized data based on the prediction, and delivering an output to a user based on the analysis.

Description of Related Art

Data analytics relates to the study of raw data for the purpose of developing conclusions about what the raw data represents. Conclusions inferred from such data analysis can be helpful for example to businesses interested in developing and implementing more effective marketing, communications, or sales strategies. Data analytics can include the measurement, collection, analysis, and reporting of data from websites or other electronic data sources. Such measures of interest may include web analytics, such as the number of visitors, number of unique visitors, whether they visited the site directly or followed a link, keywords searched on the website's search engine, time spent visiting a given page or the entire site, which links were clicked on, and when the visitor left the website. In addition to collecting raw data for performing web analytics, raw data can be collected from various electronic data sources such as social media sites for evaluating or tracking user trends. Data analytics is also a useful tool in the area of commerce for monitoring sales and forecasting sales projections. Data analytics can also be used as a market research tool as it helps determine past and predicted website traffic, revenue attributable to a particular social media campaign, and popularity trends.

Efforts in this area include those described in U.S. Pat. Nos. 8,583,584 and 8,554,699. The best predictive model to use with data analytics data, however, is currently unknown. For example, U.S. Patent Application Publication No. 20140108640 characterizes the predictive model of moving average analysis as “man-hour intensive” and states that “some web analytics data may have a cyclical nature that is poorly suited to moving average analysis.” Thus, it can be seen that there is still a need in the art for new methods that address these limitations.

### SUMMARY OF THE INVENTION

In embodiments, the present invention provides a computer-implemented method for performing digital intelligence that includes several functions including aggregating, normalizing, predicting, analyzing, and/or alerting. Methods of the invention can connect to and fetch information of interest (such time-series data) from multiple arbitrary sources, including Google Analytics, Facebook, Twitter, Shopify, Mailchimp, Stripe, web services, internal databases, and static .csv files, etc. Additionally, embodiments of the methods can normalize data from a variety of formats, which is especially helpful when extracting electronic data from multiple, different sources with typically incompatible data formats. Further, embodiments of the invention use various prediction models to forecast observations over different time periods. The available prediction models fall somewhere on the power-complexity curve (i.e. the more powerful a prediction model, the more complex the prediction model is typically). Embodiments of the invention attempt to find the optimal balance between powerful, yet simple predictive models. In an exemplary embodiment, the prediction is made through autoregressive integrated moving average (ARIMA). In addition, the invention, in embodiments, can perform analysis in many forms, such as identifying anomalies in the data obtained, as well as compound metrics, interpretation of events, correlations between events, and recommendations based on activity. Finally, embodiments can send a push notification to a user based on the analysis, such as by email, SMS, voice message, or mobile notification.

Specific embodiments include a data analytics method comprising:

at a computer comprising one or more processors and a non-transitory memory for storing programs to be executed by the processors:

extracting a selection of point observation data from each of multiple different electronic data sources;

identifying time-series data within the point observation data and converting the time-series data into a plurality of reference (time, value) pairs;

normalizing the reference (time, value) pairs using a coherence operation to convert the point observation data into interval observation data;

storing the reference (time, value) pairs on a non-transitory computer-readable medium as a compilation of reference (time, value) pairs;

processing the compilation of reference (time, value) pairs with a prediction algorithm to provide a predicted value for current (time, value) pairs;

obtaining current (time, value) pairs from one or more of the multiple and different electronic data sources; and comparing one or more of the current (time, value) pairs to the predicted value to determine if the current (time, value) pair is an anomaly.

In method embodiments of the invention, the prediction algorithm can be configured to provide a predicted value for current (time, value) pairs based on analyzing averages of the data represented by the reference (time, value) pairs by accounting for qualitative changes in the data and the rate at which the averages of the data change over time, such as an ARIMA type algorithm.

### BRIEF DESCRIPTION OF THE DRAWINGS

The accompanying drawings illustrate certain aspects of embodiments of the present invention, and should not be used to limit the invention. Together with the written description the drawings serve to explain certain principles of the invention.

FIG. 1 is a schematic diagram showing an embodiment of a computer-implemented method of the invention.

FIG. 2 is a schematic diagram showing an embodiment of a computer system of the invention.

FIG. 3 is a screenshot image illustrating a graphical user interface (GUI) for altering a user of the data analytics systems and methods of the invention that an anomaly was detected in the data analyzed, i.e., an increase in web traffic.

FIG. 4 is a screenshot image illustrating a GUI for showing which sources of electronic data are being monitored by the data analytics systems and methods and providing the ability to change the monitoring scheme, e.g., provide the user with the ability to control the scope of monitoring, e.g., the user interacting with the GUI can delete or add one or more data sources to the number of sources being monitored.

FIG. 5 is a table of a set of observations showing a predicted value for each data point in the data set and whether the actual value for each data point is anomalous or within a prediction band for that data point.

### DETAILED DESCRIPTION OF VARIOUS EMBODIMENTS OF THE INVENTION

Reference will now be made in detail to various exemplary embodiments of the invention. It is to be understood that the following discussion of exemplary embodiments is not intended as a limitation on the invention. Rather, the following discussion is provided to give the reader a more detailed understanding of certain aspects and features of the invention.

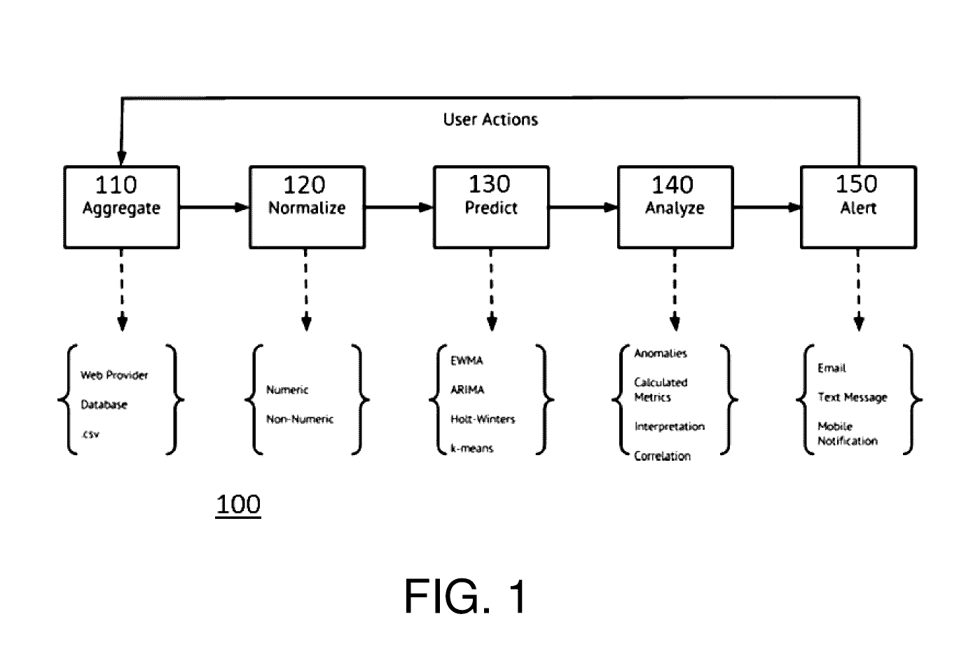

FIG. 1 is a schematic diagram showing an embodiment of a computer-implemented method 100 of the invention. In brief, an embodiment of the computer-implemented method of the invention performs the following steps: aggregate data from arbitrary sources 110, normalize input 120, make predictions 130, analyze data 140, and alert users 150. The various methods as illustrated in the figures and described herein represent examples of embodiments of methods. The methods may be implemented in software, hardware, or a combination thereof. The order of method may be changed, and various elements may be added, reordered, combined, omitted, modified, etc. In one embodiment, the method is performed on a computer network which includes a computing platform that is remote to a user. The computing platform comprises one or more servers, one or more databases, a processor, and a memory that has a set of computer-executable instructions for directing the processor to perform the steps of the method. Each step in the method will be elaborated below.

Aggregate Data from Arbitrary Sources (110)

In one embodiment, the method comprises aggregation which may first include connecting to an arbitrary data source that provides time-series data. The data source may include social media websites or platforms, any website, Google Analytics, Google Plus, Instagram, Pinterest, Facebook, Twitter, Shopify, Mailchimp, and Stripe. Other data sources may include web services, internal databases, and static .csv files. Indeed, any source of electronic data (otherwise referred to as e-data) can be used. The electronic data can be provided before implementing methods according to embodiments of the invention, or can be collected as part of the methods. After connecting to the data source, the method may comprise authorization on behalf of a third party, such as for example, when a user grants the system of the invention access to their accounts. The method may integrate with the authorized data source to retrieve the data, and standardize the data source. The data can be collected and standardized into (time, value) pairs, called observations, and additional information can be attached to the observations such as currencies, timezones, text, and more. Such data may include, but is not limited to revenue, file download views, successful sign-ins, returning customer count, product registrations, click-throughs, bounce rate, referrals, impressions, visitors, visits, page views, and conversions or conversion rate. In this embodiment, the arbitrary data sources that provide time-series data may be accessed through a network such as the Internet by one or more servers which serve as aggregation servers, and stored in a database. Method steps can be performed at a computer comprising one or more processors and memory for storing programs to be executed by the processors. The one or more servers may be operably connected to a processor which converts the time-series data to (time, value) pairs. For example, for a given a list of transactions, where each transaction has a timestamp, the email of the user who made it, and the revenue generated, if a measure of revenue generated by each transaction is desired, each transaction can be mapped to a (time, revenue) pair. The (time, value) pairs, or observations, may then be stored in a database that is operably connected to the one or more servers.

### Normalize Input (120)

Embodiments of the invention may accept two types of observations, numeric and non-numeric, both of which can be normalized according to embodiments of the invention. Further, observations may correspond to an interval of time (e.g. number of website visitors today), or to a point in time (e.g. cumulative sales made to date). Because observations can be arbitrarily frequent or infrequent, and not necessarily corresponding to the same timing interval, generally one is interested in normalizing observations so that they are equally spaced apart in some convenient way (by hour, by day, by month, et cetera), called the period. In other words, the observations are normalized so that they are on the same time scale.

To normalize the numeric observations in a set of observations, embodiments of the invention may perform a coherence operation. First, every point observation is converted into an interval observation that takes place over time interval [t, t′], where t is the point observation's time and t′ is the next point observation's time. Second, for the last point observation in the set, t′ is the current time. Each observation converted this way is a processed observation. To construct a normalized observation for a period, the values for each set of processed observations whose intervals overlap with that period are weighed according to how much of the period they occupy. Next, the mean weighed value of each such processed observation becomes the normalized observation's value, while the normalized observation's time is the interval corresponding to the period.

To normalize the non-numeric observations, embodiments of the invention may first determine pertinent metric-specific information, which involves keeping some (or all) data related to an observation and throwing away the remainder. For example, normalizing tweets may include the tweet content, author, and date posted, but exclude the location of the tweet. Each piece of information retained is then normalized individually. For example, if there are numbers here they'd be normalized like any other metric. Then, any normalization that is required is applied at the metric level, such as for example, smoothing out temporal discontinuities.

The normalization of the numeric and non-numeric observations may be performed with a processor according to a set of computer-executable instructions stored in memory. The normalized observation values may then be stored on a non-transitory computer-readable medium, such as in a database.

Make Predictions (130)

In embodiments, the method of the invention may then choose a prediction algorithm for each set of normalized observations one wants to make a prediction about. The prediction algorithm should have the following properties, including accepting a sequence of equally spaced (time index, value) pairs as input, accepting a number of sequential predictions to make, and returning a sequence of (time index, predicted value, predicted low, predicted high) tuples as output. The output may include a predicted value which is the most likely value, such as low which is the lowest value predicted to occur, and high which is the highest value predicted to occur.

In a preferred embodiment, the prediction algorithm is an autoregressive integrated moving average (ARIMA) algorithm. ARIMA is a statistic, a way of measuring some attribute of a set of data, which tries to summarize a data set by fitting it to a particular model. The better the fit to the model, the more accurately (it is hoped) future points in the dataset can be predicted.

In the ARIMA embodiment, the model tries to summarize the data with three mutually orthogonal components: an autoregressive (AR) component, an integrated (I) component, and a moving-average (MA) component.

The autoregressive component measures how linearly the data depends on some number of previous values; this number is the autoregressive order parameter and is frequently denoted as “AR(X)”, where X is the value of the order parameter. For example, a data set that is modeled well by an autoregressive model is the output production of an electrical plant with a fixed generating capacity; the prediction for each new day is likely to be strongly related to what happened the previous day, but not so much what happened on days prior to that. We might try to model this by setting the autoregressive parameter to 1, creating an AR(1) model. There are other variables to resolve, like the strength of each past day's contribution, but in general, the order parameter will matter the most.

The moving-average component measures how well the data can be measured by a linear regression of a particular order, called the moving-average order parameter, and is frequently denoted as “MA(X)”, where X is the value of the order parameter. For example, a data set that represents the level of water in an ecosystem that has an aquifer, along with groundwater levels and other factors as inputs, might be modeled by an MA model.

Finally, the integrated component measures how stationary the data is—that is, how stable its other properties are when shifted backwards or forwards in time. The integrated order parameter describes how many terms to shift to achieve maximal stationarity, and is denoted as “I(X)”, where X is the value of the order parameter.

Together, these three order parameters describe a model which is capable of predicting a broad class of series with a great degree of accuracy, at the expense of being unable to model certain kinds of complex behavior well.

The selection of the parameters is accomplished by iteratively trying parameter values and measuring the consequent fitness of the results. The initial set of parameter values is seeded from analysis of training timeseries data that is expected to be similar in a general way to the input timeseries data. For example, if it is expected that much of the input data will show strong weekly periodicity, and one data point is generated per day, then we might choose to start with I(7), setting 7 as the order parameter for the integrated component.

After initial seeding, subsequent parameter sets are selected by generating several candidate parameter sets (CPSs) by randomly perturbing the original parameter set. Each CPS is tried in turn, and the best one is then selected for a new round. These iterative rounds continue until a configurable maximum number of rounds is reached (e.g. 100 rounds) without seeing a total improvement above some error threshold (e.g., 1%). At that point, the resulting candidate set is the winner and is used to perform the prediction algorithm.

When using ARIMA as the prediction algorithm, there are an infinite number of [AR, I, MA] parameter sets that can be used. For example, any combination of one or more of the following parameter sets can be used, including [0, 0, 0], [1, 0, 0], [1, 1, 0], [1, 1, 1], [0, 0, 1], [0, 1, 1], [0, 1, 0], [1, 0, 1], [2, 0, 0], [2, 2, 0], [2, 2, 2], [0, 0, 2], [0, 2, 2], [0, 2, 0], [2, 0, 2], [2, 1, 1], [2, 2, 1], [1, 1, 2], [1, 2, 2], [1, 2, 1], [2, 1, 2], [3, 0, 0], [0, 3, 0], and so on. To reduce the strain on computing resources, the model can be configured to try a limited number of parameter sets, including any 2-64 specific combinations. For example, 2, 4, 6, 8, 10, 12, 14, 16, 18, 20, 22, 24, 26, 28, 30, 32, 34, 36, 38, 40, 42, 44, 46, 48, 50, 52, 54, 56, 58, 60, 62, or 64 of the specific combinations can be used. In specific embodiments, any 2-14 combinations selected from [0, 0, 0], [1, 0, 0], [1, 1, 0], [1, 1, 1], [0, 0, 1], [0, 1, 1], [0, 1, 0], [1, 0, 1], [2, 0, 0], [0, 0, 2], [2, 0, 2], [2, 1, 1], [1, 1, 2], or [2, 1, 2] can be used, such as 2, 4, 6, 8, 10, 12, or all 14 of these combinations. In embodiments, for example, any number of parameter sets can be used so long as the specific parameter sets of [0, 0, 0], [1, 0, 0], [1, 1, 0], [1, 1, 1], [0, 0, 1], [0, 1, 1], [0, 1, 0], and [1, 0, 1] are used in the algorithm, or at least any six of these parameter sets are used. In embodiments, any of the following combinations of AR, I, and MA can be used in the ARIMA algorithm, including where any of AR, I, and MA are chosen from 0, 1, 2, and 3, such as where AI is chosen from 0, 1, 2 and I is chosen from 0, 1 and MA is chosen from 0, 1, 2, such as any number of sets chosen from any of the following: [0, 0, 0], [0, 0, 1], [0, 0, 2], [0, 1, 0], [0, 1, 1], [0, 1, 2], [1, 0, 0], [1, 0, 1], [1, 0, 2], [1, 1, 0], [1, 1, 1], [1, 1, 2], [2, 0, 0], [2, 0, 1], [2, 0, 2], [2, 1, 0], [2, 1, 1], and [2, 1, 2]. Limiting the analysis to a select group improves prediction speed.

Other embodiments may use other prediction algorithms, including exponentially-weighted moving average (EWMA), Holt-Winters and other periodic exponential weighted moving average forecasting methods, support vector machine (SVM) classifiers, k-means classifiers, and ensemble modeling (a tuned, arbitrary, weighted combination of any of the above, plus any additional models).

Other embodiments may also use different optimization heuristics for selecting the parameters, including simulated annealing, genetic programming, hill-climbing, dynamic relaxation, and tabu search.

In embodiments, the prediction algorithm(s) may be implemented in computer executable instructions stored in a memory to be executed by a processor.

Analyze Data (140)

Embodiments of the invention may analyze the data to identify anomalies. Predictions are compared with current observations; specifically, the value of a new observation is compared with the predicted range. If the observed value is outside of the predicted range [low, high], then an anomaly is identified.

In other embodiments, the method of the invention combines metrics from different data sources to create compound metrics, such as synthetic, novel key performance indicators that are not represented in any individual metric. Compound metrics create unique combinations that provide users with a higher level of insight into their data. Examples would include average revenue per website visitor (revenue for a period divided by website visitors for same period), social media effectiveness (Twitter followers divided by Facebook fans), social media influence (Twitter followers divided by Twitter following), Facebook advertising effectiveness (Facebook page impressions divided by Facebook page visits), average revenue per app download (revenue for a period divided by app downloads for same period), among others. Another example includes revenue attributed to increased traffic resulting from a marketing campaign.

In other embodiments, the methods of the invention explain the meaning of certain events. The interpretation can range from generic (e.g. increased engagement on Facebook means you are doing something right) to personalized (e.g. your increased Facebook engagement is a result of this specific action). For example, a higher bounce rate implies a different type of visitor to your website.

In other embodiments, the methods of the invention determine correlations between events such that two (or more) events that are related to each other are identified. This determines which actions are successful or unsuccessful. For example, the methods may be used to determine whether increased website traffic has or has not resulted in increased sales or whether increased advertising expenditures have or have not resulted in increased website traffic.

In other embodiments, the method provides recommendations for specific actions to take based on activity in a user's data. These recommendations assist a user to increase positive activity or fix negative activity. “Since Pinterest drives 38% of your sales, you should “pin” more items there” is an example of the type of recommendation provided. Other examples include “your website traffic is lowest during summer months, so you should increase advertising during that time” and “only 10% of your traffic comes from the West Coast, so you should increase advertising there.”

In embodiments, the analysis may be performed by a processor according to a set of computer-executable instructions stored in memory.

Alert Users (150)

In embodiments, the methods include taking some useful notification action, which may be in the form of e-mail, text message, mobile notification, etc. Notifications can range from real-time alerts to weekly summaries to one-off recommendations/reminders. Notifications may also be determined and scheduled proactively or may be user-driven (e.g. scheduled reminders, threshold-based alerts, etc.). The notifications may include alerts or results of analyses such as compound metrics, interpretations, correlations, and recommendations.

Embodiments of the invention may optionally store the notifications in a message database and deliver them through a message server according to a set of computer-executable instructions for delivering the notifications.

Computer-Executable Instructions

It will be understood that the method steps depicted in FIG. 1 and described in this specification may be carried out by a group of computer-executable instructions that may be organized into routines, subroutines, procedures, objects, methods, functions, or any other organization of computer-executable instructions that is known or becomes known to a skilled artisan in light of this disclosure, where the computer-executable instructions are configured to direct a computer or other data processing device such as a processor to perform one or more of the specified processes and operations. The computer-executable instructions may be written in any suitable programming language or languages, including Ruby, Go, C, C++, C#, Visual Basic, Java, Scala, Python, Perl, PHP, and JavaScript.

Computer-Readable Medium

Embodiments of the invention also include a non-transitory computer readable medium comprising one or more computer files comprising a set of computer-executable instructions for performing one or more of the calculations, steps, processes and operations described and/or depicted herein. In exemplary embodiments, the files may be stored contiguously or non-contiguously on the computer-readable medium. Embodiments may include a computer program product comprising the computer files, either in the form of the computer-readable medium comprising the computer files and, optionally, made available to a consumer through packaging, or alternatively made available to a consumer through electronic distribution. As used in the context of this specification, a “computer-readable medium” includes any kind of computer memory such as floppy disks, conventional hard disks, CD-ROM, Flash ROM, non-volatile ROM, electrically erasable programmable read-only memory (EEPROM), and RAM. In exemplary embodiments, the computer readable medium has a set of instructions stored thereon which, when executed by a processor, cause the processor to perform the steps depicted in FIG. 1 and described in this specification. The processor may implement this process through any of the procedures discussed in this disclosure or through any equivalent procedure.

In other embodiments of the invention, files comprising the set of computer-executable instructions may be stored in computer-readable memory on a single computer or distributed across multiple computers. A skilled artisan will further appreciate, in light of this disclosure, how the invention can be implemented, in addition to software, using hardware or firmware. As such, as used herein, the operations of the invention can be implemented in a system comprising any combination of software, hardware, or firmware.

Computers or Devices

Embodiments of the invention include one or more computers or devices loaded with a set of the computer-executable instructions described herein. The computers or devices may be a general purpose computer, a special-purpose computer, or other programmable data processing apparatus to produce a particular machine, such that the one or more computers or devices are instructed and configured to carry out the calculations, processes, steps, and operations of the invention. The computer or device performing the specified calculations, processes, steps, and operations may comprise at least one processing element such as a central processing unit (i.e. processor) and a form of computer-readable memory which may include random-access memory (RAM) or read-only memory (ROM). The computer-executable instructions can be embedded in computer hardware or stored in the computer-readable memory such that the computer or device may be directed to perform one or more of the processes and operations depicted and/or described herein.

Computer Systems

Additional embodiments of the invention comprise a computer system for carrying out the computer-implemented method of the invention. The computer system may comprise a processor for executing the computer-executable instructions, one or more databases and servers, and/or a user interface, and a memory with a set of instructions (e.g. software) for carrying out the method. The computer system can be a stand-alone computer, such as a desktop computer, a portable computer, such as a tablet, laptop, PDA, or smartphone, or a set of computers connected through a network including a client-server configuration and one or more database servers. The network may use any suitable network protocol, including TCP/IP, UDP, or ICMP, and may be any suitable wired or wireless network including any local area network, wide area network, Internet network, telecommunications network, Wi-Fi enabled network, or Bluetooth enabled network. In one embodiment, the computer system comprises a computer connected to the internet that has the computer-executable instructions stored in memory that is operably connected to one or more databases and servers. The computer may perform the computer-implemented method based on input and commands received from remote computers through the internet.

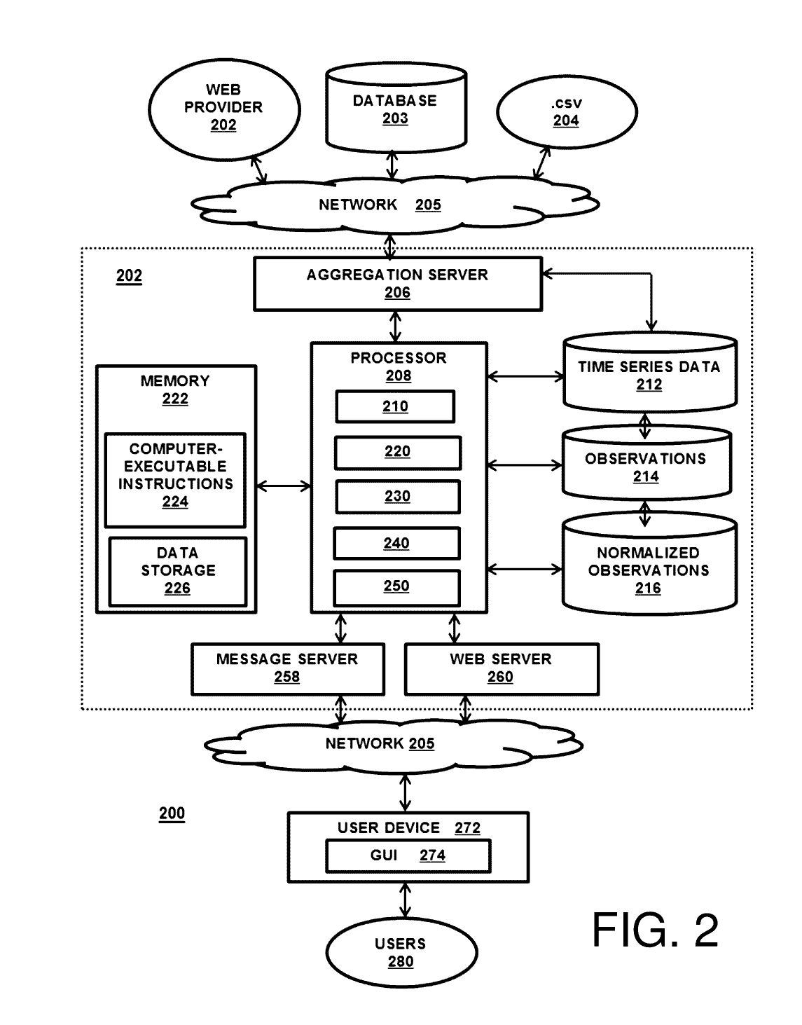

FIG. 2 shows a computer system 200 embodiment of the invention. However, the system in FIG. 2 is merely one possible configuration and other configurations that perform the steps of the method are possible as an ordinarily skilled artisan would recognize. The computer system may include any combination of hardware or software that can perform the indicated functions, including computers, databases, network devices, servers, internet appliances, PDAs, wireless phones, pagers, etc. In addition, the functionality provided by the illustrated components may in some embodiments be combined in fewer components or distributed in additional or substituting components. Similarly, in some embodiments, the functionality of some of the illustrated components may not be provided and/or other additional functionality may be available. In the embodiment shown in FIG. 2, sources of time-series data including web providers 202, databases 203, and .csv files 204 are accessible through a network 205 by an aggregation server 206, which is a component of a computing platform 202 at a location that is remote to a user 280 or on a user computer. Computing platform includes servers 206, 258, 260, databases 212, 214, 216, processor 208, and memory 222, each of which will be described in further detail below. Aggregation server 206 downloads time-series data and stores it in a database 212. Processor 208 performs the steps of the method (aggregate 210, normalize 220, predict 230, analyze 240, and alert 250) according to a set of computer-executable instructions 224 stored in a memory 222, which also has data storage capacity 226. As part of aggregate step 210, processor converts time-series data 212 to observations and stores it in a database, which can be a separate database 214. Additionally, normalize function 220 normalizes observations and stores it in a database, which can be a separate database 216. As described above, predict function 230 is an algorithm encoded in computer executable instructions 224 executed by the processor which predicts future observations which works in concert with analyze function 240 to identify anomalies in the observations. When an anomaly is identified, alert function 250 instructs message server 258 to send an alert (optionally from a message database, not shown) through the network 205 to a user device 272, which may be a desktop computer, laptop computer, tablet, or smartphone. User device 272 also has graphical user interface 274 such as a webpage which allows users 280 to access web server 260 through which the user may instruct processor 208 to access specific sources of time-series data 202, 203, 204 through aggregation server 206.

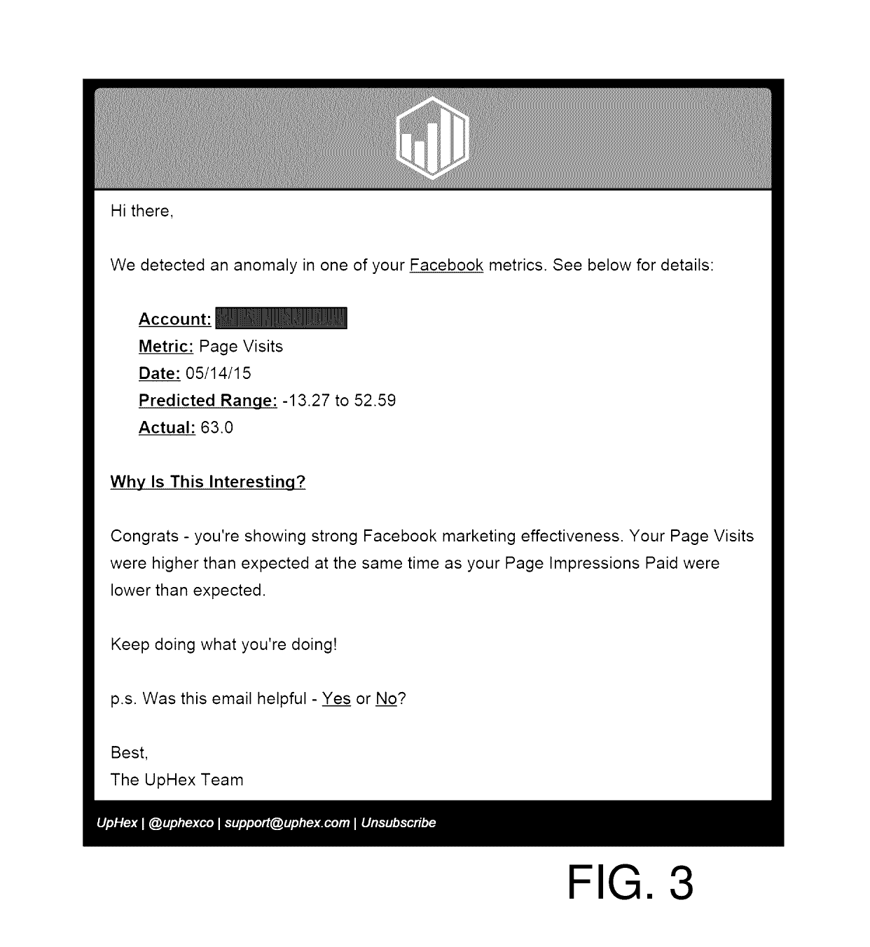

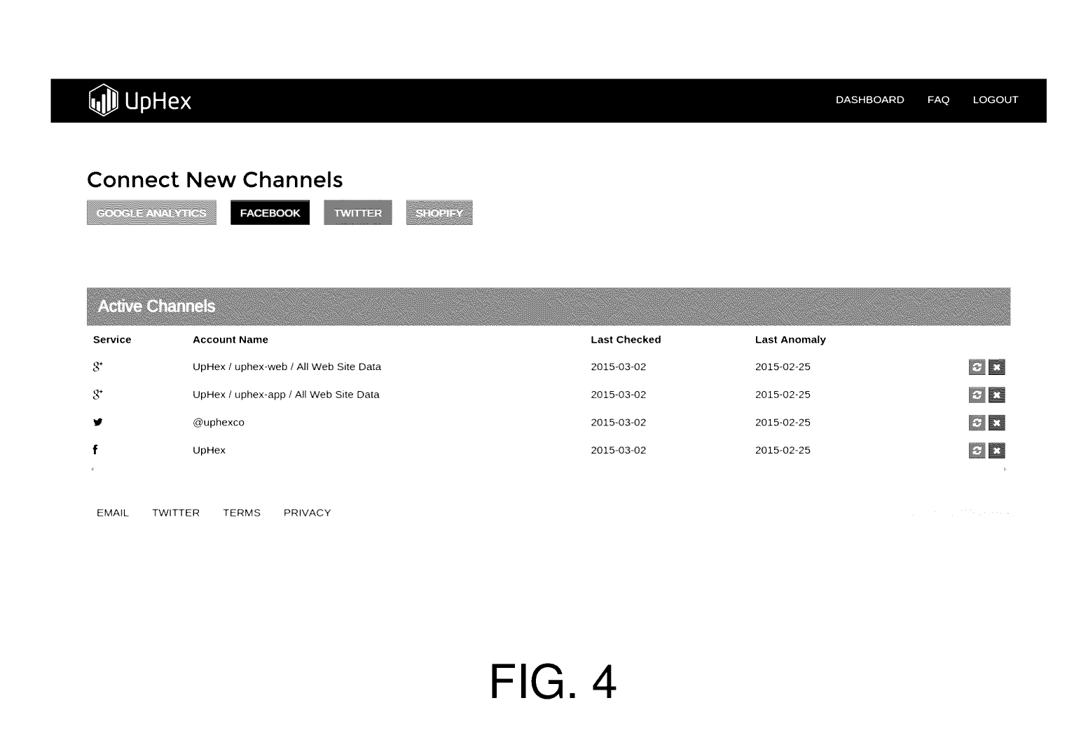

The user interface may be a graphical user interface which may be used in conjunction with the computer-executable code and databases. For example, the graphical user interface may allow a user to perform the steps depicted in FIG. 1 and described in this specification. FIG. 3 provides a screenshot image illustrating such a graphical user interface (GUI). As shown in FIG. 3, the GUI can be used to present information to a user relating to results of the data analytics systems and methods of the invention. Here, a user is altered using the GUI that an anomaly was detected in the data analyzed, e.g., an increase in web traffic was observed without an associated increase in web-related advertising. Further, for example, FIG. 4 provides a screenshot image illustrating a GUI for showing which sources of electronic data are being monitored by the data analytics systems and methods. The GUI also provides the ability to change the monitoring scheme by providing the user with the ability to control the scope of monitoring, e.g., the user interacting with the GUI can delete or add one or more data sources to the number of sources being monitored. The graphical user interface may allow a user to perform these tasks through the use of text fields, check boxes, pull-downs, command buttons, and the like. For example, the interface may allow a user to choose sources of time series data for analysis. A skilled artisan will appreciate how such graphical features may be implemented for performing the tasks of the invention. The user interface may optionally be accessible through a computer or mobile device connected to the internet. In one embodiment, the user interface is accessible by typing in an internet address through a web browser and logging into a web page. The user interface may then be operated through a remote computer accessing the web page. In one embodiment, the graphical user interface presents time-series data and anomalies for a data source in the form of alerts on a display of a client computer having a user input device. In another embodiment, the graphical user interface displays the outputs of other types of analyses, including compound metrics, interpretations, correlations, and recommendations.

Such graphical controls and components are reusable class files that are delivered with a programming language. For example, pull-down menus may be implemented in an object-oriented programming language wherein the menu and its options can be defined with program code. Further, some programming languages integrated development environments (IDEs) provide for a menu designer, a graphical tool that allows programmers to develop their own menus and menu options. The menu designers provide a series of statements behind the scenes that a programmer could have created on their own. The menu options may then be associated with an event handler code that ties the option to specific functions. Text fields, check boxes, and command buttons may be implemented similarly through the use of code or graphical tools. A skilled artisan can appreciate that the design of such graphical controls and components is routine in the art.

### EXAMPLE

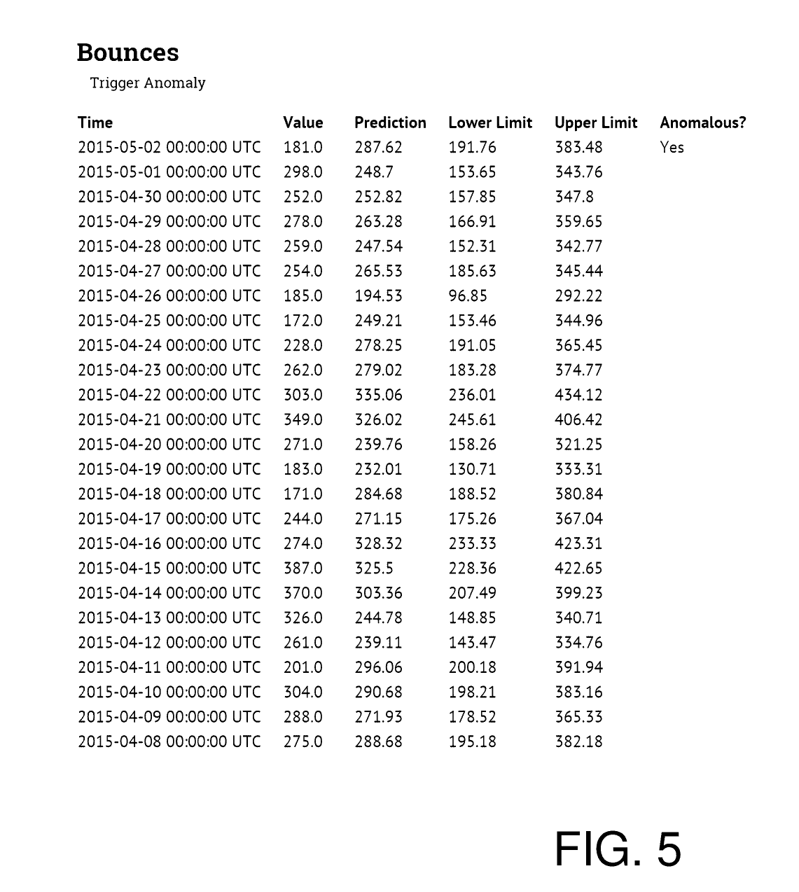

Methods of identifying anomalies in electronic data can be performed using the data analytics techniques provided in this disclosure. FIG. 5 illustrates an example of how an anomaly can be identified according to embodiments of the invention. As shown in FIG. 5, a set of historical data is extracted or isolated from one or more electronic data source. Associated with each observation or data point is a timestamp, which timestamp can be used to distinguish the data points from one another. Typically, the timestamp will represent the time the observation was fetched from the electronic data source, and the timestamp for all data in the data set is typically provided in a common format, such as in UTC (Coordinated Universal Time). The value of each data point is also observed. A predicted value for each data point is calculated using one or more prediction algorithms, such as ARIMA, and a prediction band is generated for each predicted value representing a range of predicted values that would be considered normal or non-anomalies. A lower limit and upper limit are assigned to each prediction band representing the extremes of the normal range. The actual value observed for each data point is then compared with the prediction band for that data point. Any data point falling outside the predicted band for that data point is identified as anomalous. The anomalous data points can be analyzed to determine whether certain actions should be recommended in response to the anomalies to promote a desired effect or future response, such as recommending certain actions that would avoid future anomalies or actions that would increase the number of anomalies.

The present invention has been described with reference to particular embodiments having various features. In light of the disclosure provided above, it will be apparent to those skilled in the art that various modifications and variations can be made in the practice of the present invention without departing from the scope or spirit of the invention. One skilled in the art will recognize that the disclosed features may be used singularly, in any combination, or omitted based on the requirements and specifications of a given application or design. When an embodiment refers to “comprising” certain features, it is to be understood that the embodiments can alternatively “consist of” or “consist essentially of” any one or more of the features. Other embodiments of the invention will be apparent to those skilled in the art from consideration of the specification and practice of the invention.

It is noted in particular that where a range of values is provided in this specification, each value between the upper and lower limits of that range is also specifically disclosed. The upper and lower limits of these smaller ranges may independently be included or excluded in the range as well. The singular forms “a,” “an,” and “the” include plural referents unless the context clearly dictates otherwise. It is intended that the specification and examples be considered as exemplary in nature and that variations that do not depart from the essence of the invention fall within the scope of the invention. Further, all of the references cited in this disclosure are each individually incorporated by reference herein in their entireties and as such are intended to provide an efficient way of supplementing the enabling disclosure of this invention as well as provide background detailing the level of ordinary skill in the art.

1. A data analytics method comprising:
at a computer comprising one or more processors and a non-transitory memory for storing programs to be executed by the processors:
extracting a selection of point observation data from each of multiple different electronic data sources;
identifying time-series data within the point observation data and converting the time-series data into a plurality of reference (time, value) pairs;
normalizing the reference (time, value) pairs using a coherence operation to convert the point observation data into interval observation data;
storing the reference (time, value) pairs on a non-transitory computer-readable medium as a compilation of reference (time, value) pairs;
processing the compilation of reference (time, value) pairs with a prediction algorithm to provide a predicted value for current (time, value) pairs;
obtaining current (time, value) pairs from one or more of the multiple and different electronic data sources; and
comparing one or more of the current (time, value) pairs to the predicted value to determine if the current (time, value) pair is an anomaly.

2. The method of claim 1 comprising calculating a compound metric from the time-series data.

3. The method of claim 1, wherein the (time, value) pairs are normalized so that they are on the same time scale.

4. The method of claim 1, wherein the multiple different electronic data sources include websites, web services, internal databases, and/or static .csv files.

5. The method of claim 1, wherein the multiple different electronic data sources includes websites and web services.

6. The method of claim 1, wherein the electronic data includes numeric and non-numeric data.

7. The method of claim 1, wherein the numeric (time, value) pairs are normalized according to the following steps:
convert point observation (time-value) pairs that correspond to a point in time to interval observation (time, value) pairs that correspond to an interval of time that takes place over the interval [t, t′], where t is time of occurrence for a (time, value) pair and t′ is a time of occurrence for a (time, value) pair occurring next in time, and t′ is set as current time for time of occurrence of a last (time, value) pair in a set of (time, value) pairs being normalized; and
construct a normalized (time, value) pair for a period for each set of interval observation (time, value) pairs whose intervals overlap with that period, by weighting their values according to how much of the period they occupy.

8. The method of claim 1, wherein the electronic data is non-numeric and is normalized according to the following steps:
determine pertinent metric-specific information, comprising keeping a portion or all of the data related to a (time, value) pair and throwing away the remainder;
normalize each piece of data retained individually; and
apply any normalization needed at a metric level.

9. The method of claim 1, wherein observations are normalized according to the following steps:
within a set of observations, convert a point observation into an interval observation that takes place over an interval [t, t′], where t is time of occurrence of the point observation and t′ is time of occurrence of a next point observation in the set;
for a last point observation of the set, equate t′ to be current time; and
weigh values of each interval observation whose interval overlaps with the interval [t, t′] according to how much of the interval [t, t′] it occupies;
wherein mean weighted value of each interval observation becomes a normalized observation's value with a time interval of [t, t′].

10. The method of claim 1, wherein the prediction algorithm accepts a sequence of (time index, value) pairs as input, accepts a number of sequential predictions to make, and returns the following sequence as output:
time index, predicted value, predicted low, predicted high
wherein:
predicted value is a most likely value;
predicted low is a lowest value predicted to occur; and
predicted high is a highest value predicted to occur.

11. The method of claim 1, wherein the prediction algorithm is configured to provide a predicted value for current (time, value) pairs based on analyzing averages of the data represented by the reference (time, value) pairs by accounting for qualitative changes in the data and the rate at which the averages of the data change over time.

12. The method of claim 1, wherein the prediction algorithm is an autoregressive integrated moving average (ARIMA) algorithm.

13. The method of claim 12, wherein the (ARIMA) algorithm uses any group containing from 2-14 (AR, I, MA) combinations selected from [0, 0, 0], [1, 0, 0], [1, 1, 0], [1, 1, 1], [0, 0, 1], [0, 1, 1], [0, 1, 0], [1, 0, 1], [2, 0, 0], [0, 0, 2], [2, 0, 2], [2, 1, 1], [1, 1, 2], and [2, 1, 2].

14. The method of claim 1, wherein an anomaly is identified if the current (time, value) pair falls above or below a range defined by the predicted low and high.

15. The method of claim 1, wherein an alert selected from the group consisting of email, SMS, voice message, and mobile notification is sent to report whether or not an anomaly is found.

16. The method of claim 1, wherein the time-series data is selected from the group consisting of revenue, file download views, successful sign-ins, returning customer count, product registrations, click-throughs, bounce rate, referrals, impressions, visitors, visits, page views, and conversions.
